(19) United States
(12) Patent Application Publication
(10) Pub. No.: US 2016/0217397 A1
(43) Pub. Date: Jul. 28, 2016

(54) PROXIMITY REPORTING OF AN ARRIVING GUEST TO PROVIDE ENHANCED SERVICES UPON GUEST ARRIVAL

(71) Applicant: Uberguest Systems, LLC, Miami Beach, FL (US)

(72) Inventors: Klaus Peters, Los Angeles, CA (US); David F. Hampson, Marietta, GA (US)

(21) Appl. No.: 14/965,504

(22) Filed: Dec. 10, 2015

Related U.S. Application Data
(60) Provisional application No. 62/107,239, filed on Jan. 23, 2015.

(51) Int. Cl. G06Q 10/02; H04W 4/02

(52) U.S. Cl. CPC G06Q 10/02; H04W 4/02

(57) ABSTRACT

The proximity of an arriving guest can be determined and presented to the staff of a hospitality venue. The proximity of an arriving guest to the venue can be calculated using location information received from a GPS-enabled mobile application that executes on the guest's mobile device. The GPS-enabled mobile application can transmit the guest's location to a computer system that can calculate the guest's proximity to a venue based on the guest's location and the location of the venue. Once the proximity of the guest is determined, the proximity can be presented to the venue's staff. Additional information about the guest can also be presented to the staff to assist the staff in greeting the guest and customizing services to the guest's preferences once the guest arrives.

### CROSS-REFERENCE TO RELATED APPLICATIONS

This application claims priority to U.S. Provisional Patent Application No. 62/107,239 which was filed on Jan. 23, 2015.

### BACKGROUND

1. Field of the Invention

The present invention is generally directed to determining and reporting the proximity of arriving guests to a venue thus allowing staff to provide enhanced services to the guests upon arrival. In particular embodiments, the present invention can be used to determine the proximity of guests to participating hotels and to provide detailed information about such guests to the staff prior to the guests' arrival.

2. Background of the Invention

In the hospitality industry, a small percentage of guests account for a substantial amount of profits. For example, one hotel chain has estimated that the top 2% of its guests account for 30% of the hotel's profits. The profits received from these elite guests are largely due to the additional amounts they are willing to pay to receive customized and enhanced services during their stay.

For this reason, many entities provide elite programs that facilitate the identification of elite guests and the reporting of preferences of these elite guests. For example, many hotel chains, restaurants, airlines, theme parks, etc. provide rewards programs to incentivize guest loyalty and to allow guests to reach elite status.

### BRIEF SUMMARY

The present invention extends to methods, systems, and computer program products for reporting the proximity of an arriving guest to a venue. The present invention can allow staff of a venue to be informed of the pending arrival of a guest as well as preferences of the guest. Once the guest arrives, the staff can provide enhanced services to ensure that the guest's needs and expectations are met to thereby engender greater loyalty to the venue.

In some embodiments of the present invention, the proximity of an arriving guest to a venue can be monitored using a GPS-enabled mobile application that executes on the guest's mobile device. The GPS-enabled mobile application can transmit the guest's location (e.g., via a server system) to one or more computing devices located at the venue to allow the guest's proximity to the venue to be presented to the venue's staff. Additional information about the guest can also be presented to the staff to assist the staff in greeting the guest and customizing services to the guest's preferences. In some embodiments, the present invention can also allow the staff to input additional information about the guest. This additional information could be used to customize services during the guest's stay or during a subsequent visit to the same or different venue.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIG. 2 illustrates an example of how a portable computing device can report its location to a computer system;

FIG. 3 illustrates an example user interface for displaying the distance of guests from a hotel;

FIG. 4 illustrates an example user interface for displaying information about a guest;

FIG. 5 illustrates an example user interface for displaying arrival and departure information for a guest; and

FIG. 6 illustrates an example of how the present invention can be used to monitor the proximity of various guests to a hotel.

### DETAILED DESCRIPTION

The present invention extends to methods, systems, and computer program products for reporting the proximity of an arriving guest to a venue. The present invention can allow staff of a venue to be informed of the pending arrival of a guest as well as preferences of the guest. Once the guest arrives, the staff can provide enhanced services to ensure that the guest's needs and expectations are met to thereby engender greater loyalty to the venue.

In some embodiments of the present invention, the proximity of an arriving guest to a venue can be monitored using a GPS-enabled mobile application that executes on the guest's mobile device. The GPS-enabled mobile application can transmit the guest's location (e.g., via a server system) to one or more computing devices located at the venue to allow the guest's proximity to the venue to be presented to the venue's staff. Additional information about the guest can also be presented to the staff to assist the staff in greeting the guest and customizing services to the guest's preferences. In some embodiments, the present invention can also allow the staff to input additional information about the guest. This additional information could be used to customize services during the guest's stay or during a subsequent visit to the same or different venue.

Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, mobile telephones, PDAs, tablets, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Example Computer Environment

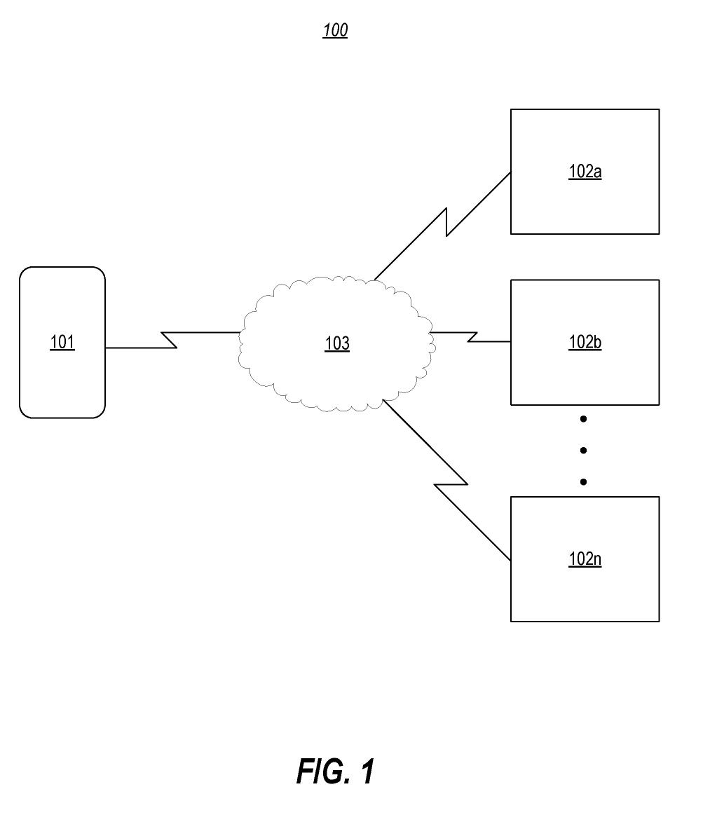

FIG. 1 illustrates an example computer environment 100 in which the present invention can be implemented. Computer environment 100 includes a portable computing device 101 that is interconnected with a plurality of other computer systems 102a-102n via a network 103 which may typically be the internet. Portable computing device 101 can typically be a smart phone or tablet; however, any portable computing device capable of identifying its location can be used. Portable computing device 101 can communicate with one or more of computer systems 102a-102n over network 103 to transmit its location as well as an identifier of the user of the device.

Computer systems 102a-102n can include computing devices or systems used by a hospitality venue. For example, if the hospitality venue is a hotel, computer systems 102a-102n can include a server that stores reservations and account information for guests, a portable computing device carried by a manager, doorman, concierge, bellhop, or other staff member, a desktop computer located at the check-in counter, concierge desk, a manager's desk, etc. In this specification, the present invention will primarily be described with reference to its implementation in a hotel. However, the present invention can also be implemented at any other hospitality venue including, for example, a restaurant, a theme park, an airport, a cruise ship, a convention, etc.

As will be further described below, in some implementations of the invention, portable computing device 101 can be configured to transmit location information to an intermediary computer system (e.g., one of computer systems 102a-102n). The intermediary computer system can then determine the proximity of portable computing device 101 to a particular venue and then send this proximity to one or more computer systems located at the venue (e.g., one or more of computer systems 102a-102n).

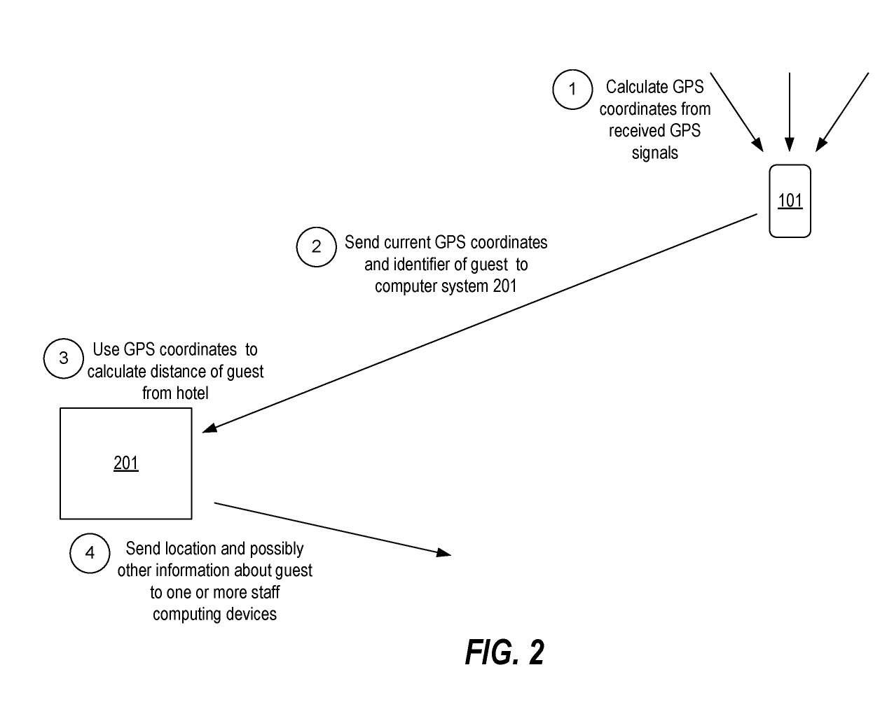

FIG. 2 illustrates an example of how portable computing device 101 can relay its location to a computer system 201. Portable computing device 101 comprises a GPS-enabled device and can therefore calculate GPS coordinates for its current location. In some embodiments of the invention, guests of a hospitality venue can be given access to a mobile application that can be installed on their smart phones or other portable computing devices. This mobile application can be configured to determine the GPS coordinates of a device's current location and route these coordinates to an appropriate computer system.

In FIG. 2, an application executing on portable computing device 101 determines the GPS coordinates of device 101 and sends these coordinates along with a guest identifier to computer system 201. Computer system 201 can represent a central computer system (e.g., a cloud-based system) that is employed by one or more hospitality venues to determine the proximity of arriving guests to the venues.

Upon receiving the GPS coordinates and the guest identifier, computer system 201 calculates the distance between a hotel where the guest has a reservation and the guest's current location. To calculate the distance of the guest from the hotel, computer system 201 can first determine the hotel where the guest has a reservation. For example, if computer system 201 manages guest proximity reporting for a number of venues, computer system 201 can use the identifier received with the GPS coordinates to look up a reservation of the corresponding guest. Then, computer system 201 can use the location of the hotel where the guest has a reservation and the GPS coordinates received from portable computing device 101 to calculate the proximity of the guest to the hotel.

In an alternative embodiment, rather than determining the location of portable computing device 101 at computer system 201, portable computing device 101 can directly calculate its distance from the hotel and transmit this distance to the hotel's computer systems. In such cases, there may be no need for an intermediary system (e.g., computer system 201) because portable computing device 101 can directly report its proximity to the hotel to one or more computer systems at the hotel. For example, the mobile application executing on portable computing device 101 can be configured to receive the GPS coordinates of the hotel where the guest has a reservation. Then, the mobile application can use its current GPS coordinates and the coordinates of the hotel to calculate the distance to the hotel. Accordingly, various configurations can be employed to calculate the distance between a portable computing device and a hotel.

Once the distance of the guest from the hotel is known, a representation of this distance can be displayed to the staff of the hotel. For example, computer system 201 can transmit the distance to a computing device carried by a concierge, bellhop, or other staff member to inform the staff member of the pending arrival of the guest. Computer system 201 can also provide information about the guest such as the name of the guest, preferences of the guest, a room for the guest, etc. to allow the staff to customize their services to the guest once the guest arrives.

In some embodiments, computer system 201 or another connected computer system can automatically check the guest into the hotel upon determining that the guest is within a specified distance from the hotel. In this way, once the guest arrives, he can be directed to his room without having to check in. For example, if the hotel employs room keys, computer system 201 can automatically check the user in and instruct the staff to prepare the room keys so that they can be handed to the guest upon his arrival.

Even after the guest has checked into the hotel, the mobile application on the guest's portable computing device 101 can continue to provide GPS coordinates to computer system 201 when the guest is away from the hotel. In this way, the proximity of the guest to the hotel can be monitored during the duration of the guest's stay to allow the staff to continue to provide enhanced services. In some embodiments, the mobile application can provide an option to turn off the reporting of location information to prevent the guest's proximity from being monitored.

Computer system 201 can be configured to report the location of any guests having reservations that are also within a specified distance of the hotel. For example, computer system 201 can identify when any guests have come within 10 miles of the hotel (using the distance calculation process described above), and then commence reporting the location of the guest to the hotel. In this way, the hotel staff can be informed early of the guest's pending arrival and can continue to monitor the guest's distance from the hotel.

In some embodiments, the mobile application executing on the guests' devices can be configured to report GPS coordinates to computer system 201 whenever the application is active. In such cases, computer system 201 can monitor the reported GPS coordinates and only route the location of the guest once the guest has come within a specified distance of the hotel. In this way, the hotel will only receive location information for guests that are within the specified distance of the hotel.

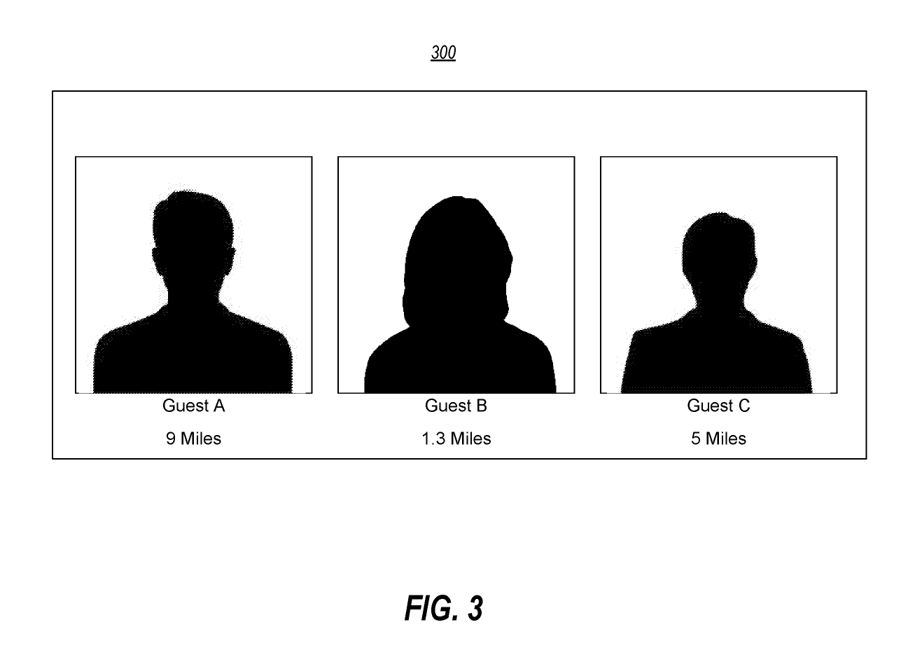

In some embodiments, an application executing on staff computing devices can be configured to receive, from computer system 201, the distance information for arriving guests (i.e. those that are within the specified distance from the hotel). This application can also be configured to display images of the arriving guests along with their distances from the hotel. FIG. 3 provides an example user interface 300 for conveying this information. User interface 300 displays images of three guests along with each guest's name and the distance of each guest from the hotel. As computer system 201 reports updated location information for each guest, user interface 300 can be updated to reflect the current location of the guests. Accordingly, user interface 300 provides up-to-date location information for each guest within the specified distance of the hotel. Although not shown, in some embodiments, user interface 300 may also display images of all guests that are arriving on that day even if these guests have not yet come within the specified distance of the hotel. Such guests could be displayed in a different manner (e.g., within a different portion of user interface 300). Displaying all guests that are scheduled to arrive on that day can further assist the staff in preparing for the guests' arrival.

The guests displayed in user interface 300 can include any guests that have a reservation at the hotel that are within a specified distance of the hotel (e.g., 10 miles) but have not yet arrived and checked in. In some embodiments, user interface 300 can also display guests that have already been checked in but are located outside of the hotel (e.g., those that have gone out for a meal, entertainment, business, etc.).

It may be desirable in some cases to distinguish between guests who have already been checked in and those who have not. For example, it may be desirable to inform staff of guests who have already checked in so that the staff does not welcome the guest to the hotel again, but instead asks the guest about his current stay. Accordingly, the image of each guest displayed in user interface 300 can be modified to indicate whether the guest has checked in or not. In a particular example, this can be accomplished by applying a colored pattern around the image of the guest (e.g., blue when checked in and red when not).

In some embodiments, the applications executing and a checked-in guest's computing device and the staff computing devices (e.g., a doorman's computing device) can be configured to communicate directly via Bluetooth or other similar wireless protocol to notify the staff when the checked-in guest is returning to the hotel. For example, if the checked-in guest leaves the hotel for dinner, the staff computing device can monitor for a Bluetooth signal generated by the checked-in guest's computing device. Upon detecting this Bluetooth signal, the staff computing device can determine that the guest is again within a specified distance (e.g., 600 feet) of the hotel and can display the guest's image and any relevant information to allow the staff to again greet the guest.

It may also be desirable to highlight guests that are about to arrive as opposed to those that are still a distance away from the hotel. For example, the display of an image in user interface 300 can be updated when the guest has come within 2 miles of the hotel. This can be accomplished in various ways such as by changing the color of the text listing the distance of the guest from the hotel or changing the color of a pattern surrounding the image of the guest. In this way, the staff can easily determine which guests are about to arrive.

By emphasizing guests that are about to arrive, the staff can be prepared to provide enhanced services to the guest upon arrival. For example, a manager of the hotel can see that a guest is about to arrive and can move to the front entrance to personally greet the guest. The staff can ensure that the guest is already checked in so that the manager can escort the guest directly to his suite without having to stand in line at the check-in counter.

In some embodiments, user interface 300 can provide an option to listen to a recording of the guest's name to ensure that the guest can be greeted using the proper pronunciation of his name For example, the guest's image or name can be selectable to cause the pronunciation to be played (e.g., via a speaker or earpiece to a doorman or bellhop). In some embodiments, the recording of the pronunciation of the guest's name can be obtained by the mobile application executing on the guest's portable computing device. For example, the mobile application can be configured to prompt the guest to record his name and then transmit this recording to computer system 201 from which it can be retrieved and played upon selection by the staff. In some embodiments, the applications executing on staff computing devices can be configured to automatically output the pronunciation of the guest's name once the guest comes within a specified distance of the hotel. For example, once the guest is within 1 mile of the hotel, each staff computing device can audibly output the pronunciation to prepare the staff to greet the guest.

In some embodiments, user interface 300 can include links to additional information about each guest whose image is displayed. For example, in some embodiments, the guest's image or name can be selectable to cause another user interface to be displayed that provides preferences or other information about the guest.

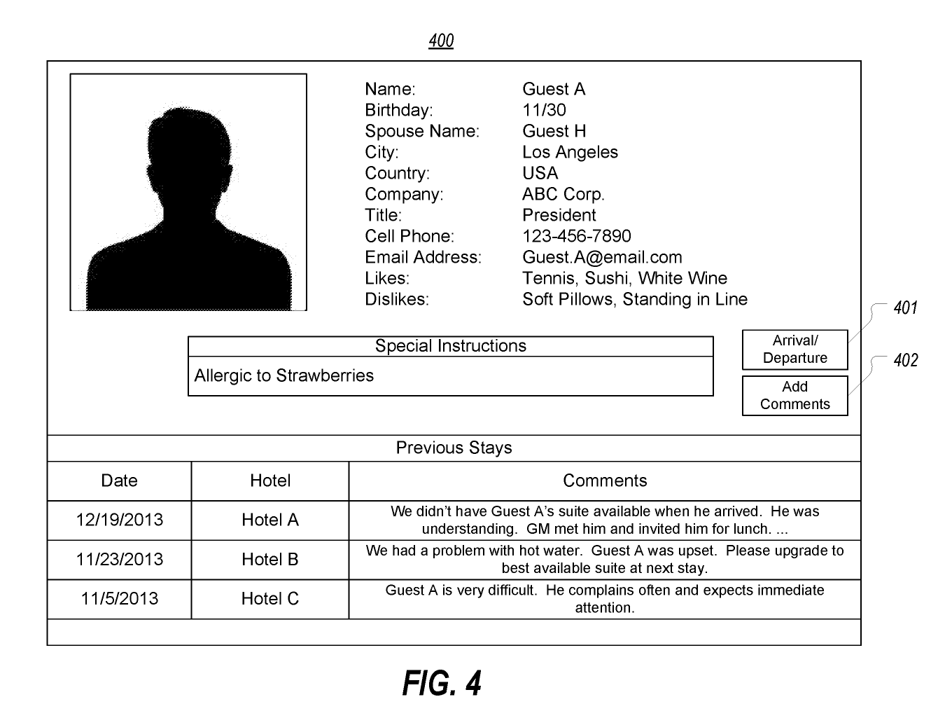

FIG. 4 provides an example of a user interface 400 that can be displayed to provide additional information about a selected guest. User interface 400 can include preferences of the guest, special instructions for the guest, a listing of the guest's previous stays at the hotel or other related hotels, comments from previous stays, etc. The information provided by user interface 400 can assist the staff in customizing its services for the guest. Also, because this information can be viewed before the guest arrives, the staff can be better prepared upon the guest's arrival to provide these services.

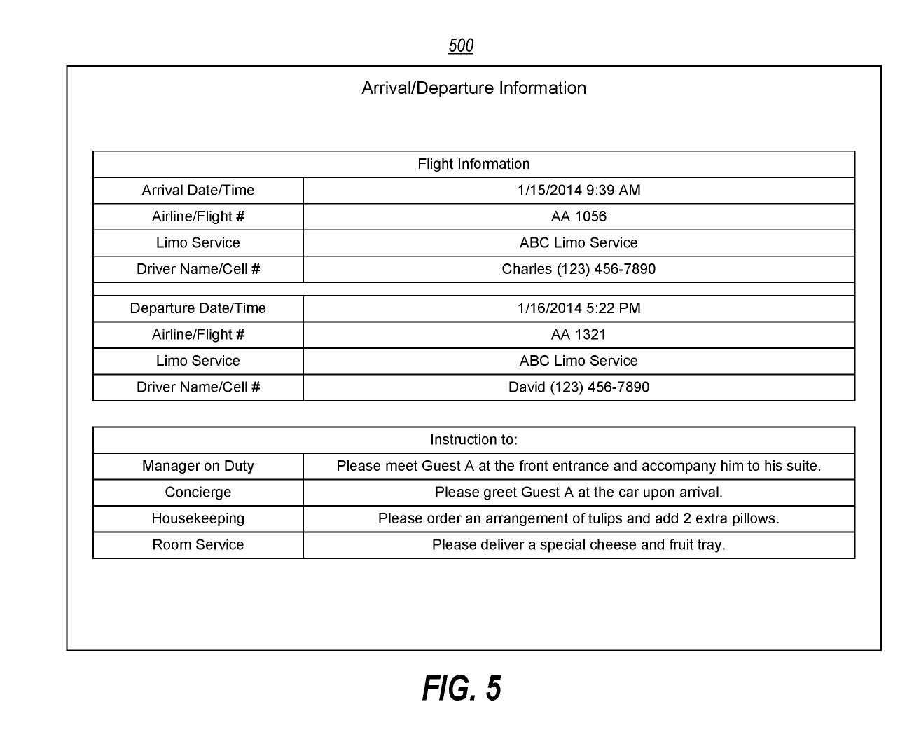

User interface 400 can also include an Arrival/Departure button 401 and an Add Comments button 402. When Arrival/Departure button 401 is selected, information about the arrival and/or departure of the guest can be presented. FIG. 5 provides an example user interface 500 that can be displayed when the Arrival/Departure button 401 is selected. As shown, user interface 500 can display information regarding when the guest's flight arrives and departs as well as how the guest is travelling to and from the hotel. This arrival and departure information can be received directly from the guest (e.g., via the mobile application executing on portable computing device 101) or input by staff. User interface 500 can also display instructions to the staff which may also be received directly from the guest or may be input by the staff.

When Add Comments button 402 is selected, a user interface can be displayed to allow the staff to input comments about the guest. For example, these comments can indicate preferences learned about the guest during the stay, experiences with the guest, instructions for future stays, etc.

In some embodiments, such as when the hotel employs a number of staff that each use a computing device to monitor the arrival of guests, user interface 300 can be configured to allow each guest to be “claimed” once the guest has come within a specified distance of the hotel (e.g., within 1 mile). For example, user interface 300 could include a “Claim” button that is displayed adjacent each image of an arriving guest. When one of the staff selects the Claim button for a particular guest, the image of that guest will be removed from user interface 300 on the other staffs' computing devices. This claiming can allow the claiming staff member to signal to the other staff members that he or she will be greeting the claimed guest.

Once a guest is claimed, user interface 300 can be updated to display a larger image of the claimed guest on the claiming staff member's computing device. The larger image can also be displayed with an option to view the claimed guest's location on a map. The map can display the exact location of the guest so that the staff member can visualize where the guest is as he or she approaches the hotel. For example, if multiple individuals happened to be approaching the hotel at the same time, the map would identify which individual is the claimed guest so that the staff member can greet the appropriate person. This map feature is particular beneficial in situations where the staff member may greet the claimed guest by opening his car door. In such cases, the staff member may not be able to visually identify the guest prior to opening the door. By showing the approach of the guest, the map feature will therefore allow the staff member to identify which car the guest is in.

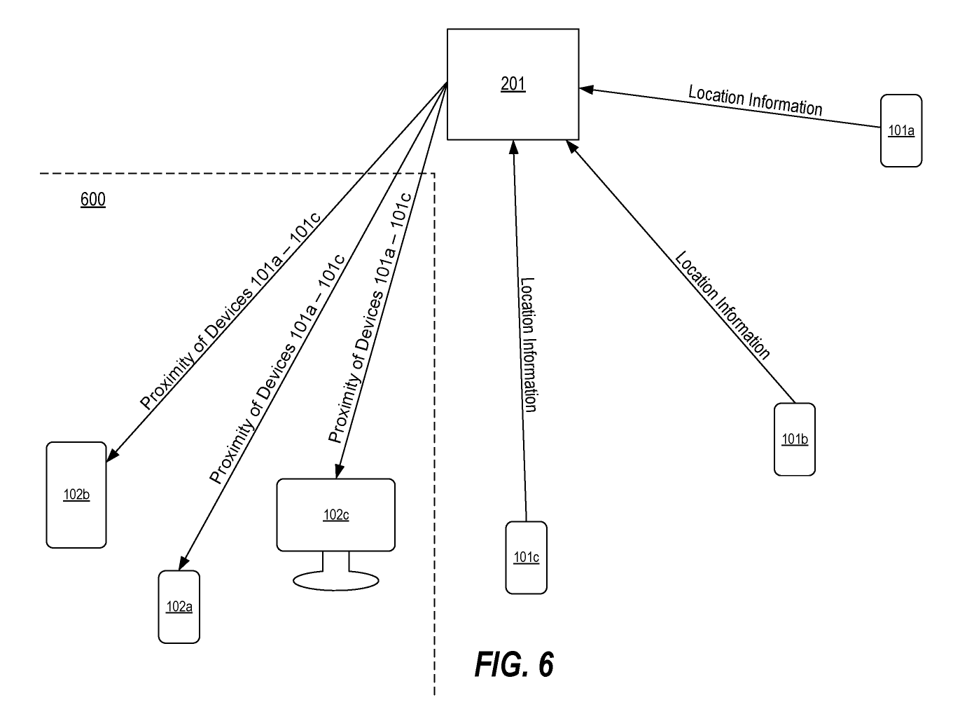

FIG. 6 provides an example of how the present invention can be used to report the proximity of three guests arriving at a hotel 600. The guests are carrying portable computing devices 101a-101c respectively which transmit location information to computer system 201. Computer system 201 uses this location information to determine the proximity of each guest to hotel 600 and then transmits the proximity of the guests to computer systems 102a-102c located at hotel 600. In this example, computer system 102a can represent a mobile phone carried by a doormen or bellhop, computer system 102b can represent a tablet used by a manager, and computer system 102c can represent a PC positioned at the check-in counter. In this way, the users of computer systems 102a-102c can be informed of the pending arrival of each guest.

Also, additional information about the guest can be presented on any of computer systems 102a-102c. This additional information can be customized depending on the system where it is displayed. For example, instructions for greeting a guest can be displayed on computer system 102a so that the doormen can be prepared to greet the guest in a preferred manner. Similarly, a guest's room preferences can be displayed on computer system 102c to ensure that the staff checks the guest into an appropriate room. Accordingly, the present invention enables the staff of the hotel to be optimally prepared for an arriving guest.

As stated above, although the above examples have related primarily to proximity reporting of hotel guests, the same techniques can be employed to report the proximity of guests of other hospitality venues. For example, the proximity of a guest of an amusement park can be reported to ensure that the guest is greeted at the gate with desired accommodations. Similarly, the proximity of a guest of a restaurant can be reported to ensure that a table is ready and drinks and appetizers are served upon the guest's arrival.

Although the present invention can be used to report proximity of any guest of a hospitality venue, in many embodiments, the present invention can be used to report proximity of only guests that have elite status with the venue. The present invention can therefore be used to engender greater loyalty among the elite guests to encourage their return visits to the venue.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method for reporting the proximity of a guest to a hospitality venue, the method comprising:
receiving, from a portable computing device carried by a guest, location information identifying the current location of the guest;
calculating a distance between the current location of the guest and the location of a hospitality venue; and
transmitting the distance to one or more computer systems located in the hospitality venue to inform one or more staff members of the hospitality venue of the guest's pending arrival.

2. The method of claim 1, wherein the location information comprises GPS coordinates of the portable computing device.

3. The method of claim 1, further comprising:
receiving additional location information from the portable computing device identifying an updated current location of the guest;
calculating the updated distance between the updated current location of the guest and the location of the hospitality venue; and
transmitting the distance to one or more computer systems located in the hospitality venue.

4. The method of claim 3, wherein transmitting the distance to one or more computer systems located in the hospitality venue comprises transmitting data that causes a modification to the appearance of an image of the guest displayed on the one or more computer systems.

5. The method of claim 4, wherein the modification to the appearance comprises a change to a color associated with the displayed image.

6. The method of claim 1, further comprising:
transmitting information about the guest in conjunction with the distance.

7. The method of claim 6, wherein the information comprises instructions for greeting the guest.

8. The method of claim 6, wherein the information comprises comments received about the guest from staff at other hospitality venues.

9. The method of claim 6, wherein the information identifies a mode of transportation that the guest is taking to arrive at the hospitality venue.

10. The method of claim 6, wherein the information includes a pronunciation of the guest's name.

11. The method of claim 10, wherein the pronunciation comprises an audio recording.

12. A method for reporting the proximity of guests who are within a specified distance from a hospitality venue, the method comprising:
receiving, from each of a plurality of portable computing devices of guests that have reservations at the hospitality venue, location information identifying the current location of the guest;
determining, for each guest, whether the guest is within a specified distance of the hospitality venue; and
upon determining that a first guest is within the specified distance, sending a distance between the current location of the first guest and the location of the hospitality venue to a computer system located at the hospitality venue to thereby enable the computer system to display the distance to one or more staff members of the hospitality venue.

13. The method of claim 12, wherein the specified distance is ten miles.

14. The method of claim 12, wherein the computer system is a portable computing device carried by one or more of the staff members.

15. The method of claim 12, further comprising:
sending an image of the first guest with the distance.

16. The method of claim 12, further comprising:
sending instructions for greeting the first guest with the distance.

17. A method for reporting the proximity of a guest as the guest is traveling to a hospitality venue, the method comprising:
receiving, at a computer system, a distance between a portable computing device carried by a guest and a hospitality venue;
determining whether the distance is less than a specified distance;
when the distance is greater than the specified distance, causing the display of an image of the guest with a first visual indication on one or more computer systems located at the hospitality venue; and
when the distance is less than the specified distance, causing the display of the image of the guest with a second visual indication on one or more computer systems located at the hospitality venue.

18. The method of claim 17, wherein the first and second visual indications are different colors.

19. The method of claim 17, further comprising:
automatically checking the guest into the hospitality venue upon determining that the distance has reached a threshold.

20. The method of claim 17, further comprising:
causing the display of instructions for greeting the guest on one or more computer systems located at the hospitality venue.
